(19) United States
(12) Patent Application Publication
(10) Pub. No.: US 2006/0274962 A1
(43) Pub. Date: Dec. 7, 2006

(54) Systems and methods for improved Gaussian noise filtering

(76) Inventor: Yi-Jen Chiu, San Jose, CA (US)

Correspondence Address: BUCKLEY, MASCHOFF, TALWALKAR LLC, 5 ELM STREET, NEW CANAAN, CT, 06840, US

(21) Appl. No.: 11/144,484

(22) Filed: Jun. 3, 2005

(51) Int. Cl. G06K 9/40

(52) U.S. Cl. 382/275; 382/260

(57) ABSTRACT

According to some embodiments, systems and methods for improved Gaussian noise filtering may be provided. In some embodiments, a system, method, and/or article of manufacture may be operable to receive, at a Gaussian noise filter, video input comprising data associated with a plurality of video pixels, identify a pixel from the plurality of pixels that is associated with an anomaly, determine if the identified pixel is a singularity pixel, filter the video input, in the case that the pixel is a singularity pixel, utilizing a singularity filter, filter the video input, in the case that the pixel is not a singularity pixel, utilizing a threshold filter, refine the filtered video input utilizing data associated with edge detection to create video output, and provide the video output to a video output device.

### BACKGROUND

Video and other images are often created, transmitted, stored, processed, and/or displayed by various electronic devices (e.g., video processors, Digital Video Disk (DVD) players or recorders, Video Cassette Recorder (VCR) devices, computers, and/or other network, display, or processing devices). Such images may, for example, be captured, streamed, encoded, decoded, compressed, decompressed, encrypted, and/or decrypted. The processing, storage, and/or transmission of the images often may, unfortunately, introduce corruption in the form of noise artifacts within the images and/or image stream. One type of noise artifact that is desirable to reduce to improve image quality is termed Gaussian noise. Gaussian noise may, for example, be described as the additive normal distribution used to model random degradation in image quality.

Conventional methods of reducing Gaussian noise, such as the motion compensation approach, may be computationally intensive and therefore reduce or otherwise hinder system performance. Other typical Gaussian noise reduction methods such as the motion adaptive and/or the use of temporal or spatial filters may also require larger amounts of processing and/or memory usage. Some less computationally intensive methods such as the spatial domain approach may not substantially affect performance, but may also not significantly improve image quality. Noise reduction methods may also be indiscriminately applied to the entire image and/or image stream, reducing the quality and/or sharpness of higher-detailed and/or noise-free image content.

### BRIEF DESCRIPTION OF THE DRAWINGS

FIG. 1 is a block diagram of a system according to some embodiments.

FIG. 2 is a block diagram of a system according to some embodiments.

FIG. 3 is a block diagram of a system according to some embodiments.

FIG. 4 is flowchart of a method according to some embodiments.

FIG. 5A and FIG. 5B are block diagrams of video image pixels according to some embodiments.

FIG. 6 is a block diagram of a system according to some embodiments.

### DETAILED DESCRIPTION

Some embodiments described herein are associated with an “image”. As used herein, the term “image” may generally refer to any type or configuration of information, data, signals, and/or packets associated with any type of image that is or becomes known. An image may, for example, comprise a still image, a digital image, a video image, a digital video image, a display image (e.g., associated with a display device such as a TV or a computer monitor), and/or any other type of image that is or becomes known. In some embodiments, such as in the case that an image is a video image, the image may comprise multiple images, frames, and/or temporal variations of the image. A video image may, for example, be defined by a stream of bits (i.e., a bit-stream). According to some embodiments, images may generally be comprised of a plurality of pixels.

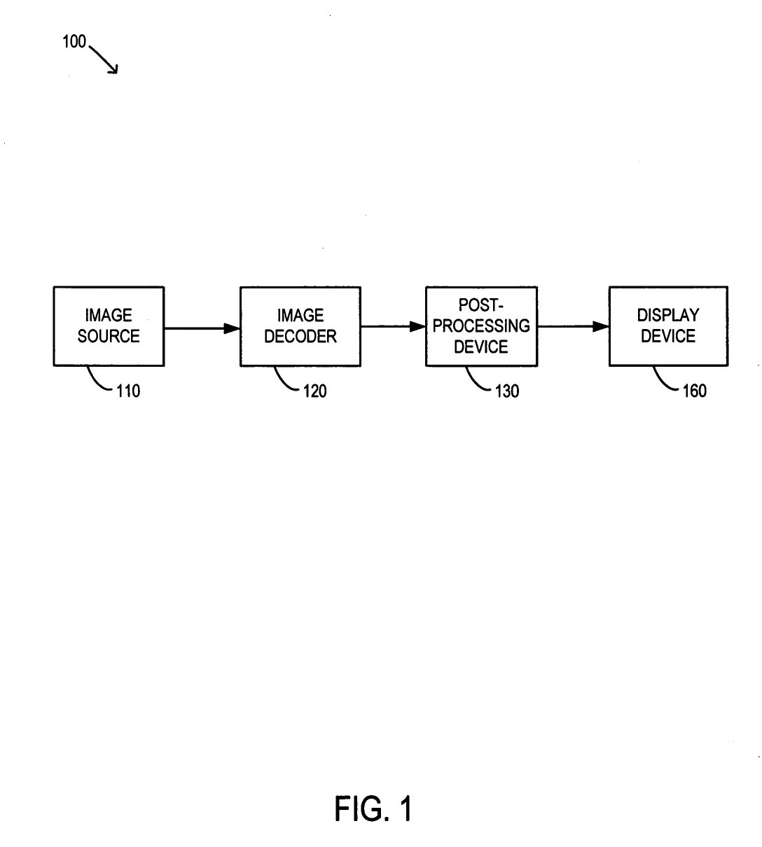

Referring first to FIG. 1, a block diagram of a system 100 according to some embodiments is shown. The various systems described herein are depicted for use in explanation, but not limitation, of described embodiments. Different types, layouts, quantities, and configurations of any of the systems described herein may be used without deviating from the scope of some embodiments. Fewer or more components than are shown in relation to the systems described herein may be utilized without deviating from some embodiments.

The system 100 may comprise, for example, an image source 110 to supply an image to an image decoder 120. The image decoder 120 may, for example, decode and/or decompress the image and/or provide the processed image to a post-processing device 130. The post-processing device 130 may, according to some embodiments, further process the image and provide the processed image to a display device 160. In some embodiments, the image may comprise a plurality of images and/or a video image bit-stream. The image source 110 may, for example, receive a video signal via a communication path (not shown) and/or may produce or reproduce a video signal from a storage medium such as a DVD, VCR tape, and/or hard drive. Examples of the image source 110 may comprise, but are not limited to, a video tuner, a DVD player, a digital camera and/or digital video camera, a VCR device, a set-top box, and/or a satellite signal reception and/or processing device. According to some embodiments, such as in the case that the image comprises a video bit-stream, the image may be compressed, encoded, and/or encrypted.

The video bit-stream may, for example, be encoded, compressed, and/or otherwise processed in accordance with the Moving Pictures Expert Group (MPEG) Release Two (MPEG-2) 13818 standard (1994) published by the International Standards Organization (ISO) and the International Electrotechnical Commission (IEC), the MPEG-4 14496 (1999/2002) standard published by ISO/IEC, the “Video coding for low bit rate communication” H.263 (February 1998) and/or the “Advanced video coding for generic audiovisual services” H.264/Advanced Video Coding (AVC) (May 2003) published by the International Telecommunication Union Telecommunication Standardization Sector (ITU-T), and/or the Advanced Systems Format (ASF) Specification Revision 01.20.2003 published by the Microsoft Corporation (December 2004).

The image decoder 120 may, according to some embodiments, be coupled to receive the image and/or video bit-stream from the image source 110. The image decoder 120 may, for example, process the image and/or video bit-stream by decompressing, decoding, and/or decrypting the image and/or video bit-stream. In some embodiments, the image decoder 120 may utilize any processing standard and/or protocol that is or becomes known. The image decoder 120 may, for example, utilize a decoding, decompression, and/or decryption protocol and/or algorithm in accordance with the protocol and/or algorithm via which the image and/or video bit-stream in encoded, compressed, and/or encrypted.

According to some embodiments, the image and/or video bit-stream may be provided by the image decoder 120 to the post-processing device 130. The post-processing device 130 may, for example, perform any number or type of processing procedures upon the image and/or video bit-stream. In some embodiments, the image and/or video bit-stream may include noise artifacts such as Gaussian noise artifacts. The transmission of the image and/or video bit-stream (e.g., to the image source 110, to the video decoder 120, and/or to the post-processing device 130), the storage and/or retrieval of the image and/or video bit-stream (e.g., associated with the image source 110), and/or the decoding, decompression, and/or decryption of the image and/or video bit-stream (e.g., by the image decoder 120) may, for example, introduce Gaussian noise artifacts into the image and/or video bit-stream. In some embodiments, the post-processing device 130 may detect, analyze, remove, and/or reduce such noise artifacts. The post-processing device 130 may, for example, operate in accordance with embodiments described herein to filter Gaussian noise.

In some embodiments, the image and/or video bit-stream may be provided to a display device 160. The post-processing device 130 may, for example, transmit the filtered image and/or video bit-stream to a computer display device, TV, and/or other display device to be viewed (e.g., by a user). According to some embodiments, the image and/or video bit-stream displayed via the display device 160 may be clearer, crisper, less noisy, and/or otherwise associated with an improved quality with respect to the image and/or video bit-stream received from the image decoder 120. The post-processing device 130 may, for example, substantially reduce and/or eliminate Gaussian noise artifacts within the image and/or video bit-stream. In some embodiments, the post-processing device 130 may also or alternatively reduce Gaussian noise artifacts while preserving the quality of non-Gaussian noise portions of the image and/or video bit-stream.

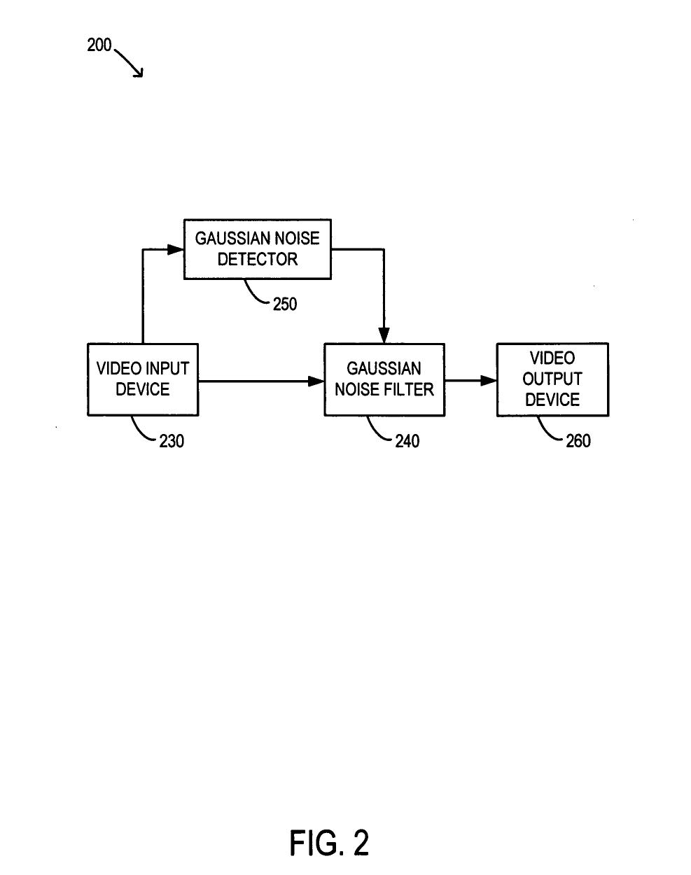

Turning to FIG. 2, a block diagram of a system 200 according to some embodiments is shown. In some embodiments, the system 200 may be similar to the system 100 described in conjunction with FIG. 1. The system 200 may comprise, for example, a video input device 230, a Gaussian noise filter 240, a Gaussian noise detector 250, and/or a video output device 260. According to some embodiments, the components 230, 240, 260 of the system 200 may be similar in configuration and/or functionality to the similarly-named components described in conjunction with FIG. 1. In some embodiments, fewer or more components than are shown in FIG. 2 may be included in the system 200.

According to some embodiments, the system 200 may be similar to the post-processing device 130 described in conjunction with FIG. 1. The system 200 may, for example, process an image to reduce and/or remove Gaussian noise artifacts. In some embodiments, the video input device 230 may be similar to the post-processing device 130. The video input device 230 may, for example, receive an image from a decoding device (such as the image decoder 120) and/or cause the image to be processed and/or filtered (e.g., by forwarding the image to the Gaussian noise filter 240 and/or the Gaussian noise detector 250. In some embodiments for example, the video input device 230 may provide a video image and/or video bit-stream to the Gaussian noise filter 240. The Gaussian noise filter 240 may, for example, process the video image and/or bit-stream to remove, decrease, and/or substantially eliminate any Gaussian noise artifacts within the video image and/or video bit-stream.

The Gaussian noise filter 240 may, according to some embodiments, analyze pixels associated with the video image and/or video bit-stream to filter Gaussian noise artifacts and/or pixels associated therewith. In some embodiments, the Gaussian noise detector 250 may also or alternatively be included in the system 200. The Gaussian noise detector 250 may, for example, analyze the video image and/or video bit-stream to determine information associated with Gaussian noise artifacts within the video image and/or video bit-stream. According to some embodiments, the Gaussian noise detector 250 may identify the presence of Gaussian noise artifacts and/or may determine the severity and/or magnitude of such artifacts.

In some embodiments, the information gathered by the Gaussian noise detector 250 may be utilized by the Gaussian noise filter 240. The Gaussian noise filter 240 may, for example, filter the video image and/or video bit-stream based at least in part on the information receiving from the Gaussian noise detector 250. According to some embodiments, the Gaussian noise filter 240 may be turned on, turned off, initiated, paused, stopped, and/or otherwise controlled based on information from the Gaussian noise detector 250. For example, in the case that the Gaussian noise detector 250 does not detect any Gaussian noise, the Gaussian noise detector 250 may send a signal to the Gaussian noise filter indicating the lack of Gaussian noise artifacts within the video image and/or video bit-stream. The Gaussian noise filter 240 may, for example, not process and/or filter the video image and/or video bit-stream until and/or unless the Gaussian noise detector identifies Gaussian noise artifacts within the video image and/or video bit-stream. In such a manner, for example, the quality of the video image and/or video bit-stream may not be unnecessarily reduced via filtering processes unless the presence of Gaussian noise artifacts warrants filtering activity.

According to some embodiments, the filtering process utilized by the Gaussian noise filter 240 may also or alternatively be altered and/or defined based at least in part upon information received from the Gaussian noise detector 250. The Gaussian noise filter 240 may adjust the intensity of the filtering process, for example, based upon a magnitude of Gaussian noise detected by the Gaussian noise detector 250. In some embodiments, the Gaussian noise detector 250 may provide other information to the Gaussian noise filter 240. According to some embodiments, the Gaussian noise filter 240 may provide the filtered video image and/or video bit-stream to the video output device 260. In such a manner, for example, the system 200 may function similar to the post-processing device 130 to filter Gaussian noise artifacts from an image. The video output device 260 may, for example, be any type or configuration of device capable of receiving, displaying, processing, transmitting, and/or storing images such as video images and/or video bit-streams. In some embodiments, the video output device 260 may comprise a TV, a computer display device, a video processing card, a video port, and/or other video display or processing device.

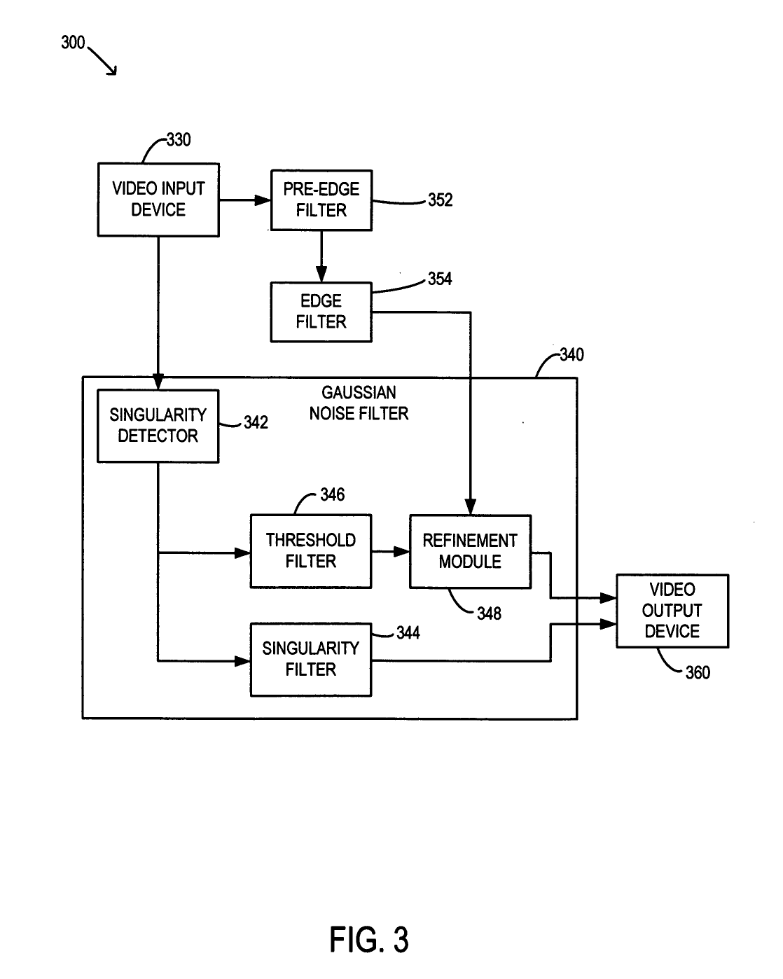

Referring now to FIG. 3, a block diagram of a system 300 according to some embodiments is shown. In some embodiments, the system 300 may be similar to the systems 100, 200 described in conjunction with any of FIG. 1 and/or FIG. 2. The system 300 may comprise, for example, a video input device 330, a Gaussian noise filter 340, a pre-edge filter 352, an edge filter 354, and/or a video output device 360. According to some embodiments, the components 330, 340, 360 of the system 300 may be similar in configuration and/or functionality to the similarly-named components described in conjunction with any of FIG. 1 and/or FIG. 2. In some embodiments, fewer or more components than are shown in FIG. 3 may be included in the system 300.

According to some embodiments, the system 300 may be similar to the post-processing device 130 described in conjunction with FIG. 1. The system 300 may, for example, process an image to reduce and/or remove Gaussian noise artifacts. In some embodiments, the video input device 330 may be similar to the post-processing device 130. The video input device 330 may, for example, receive an image from a decoding device (such as the image decoder 120) and/or cause the image to be processed and/or filtered (e.g., by forwarding the image to the Gaussian noise filter 340 and/or the pre-edge filter 352. In some embodiments for example, the video input device 330 may provide a video image and/or video bit-stream to the Gaussian noise filter 340. The Gaussian noise filter 340 may, for example, process the video image and/or bit-stream to remove, decrease, and/or substantially eliminate any Gaussian noise artifacts within the video image and/or video bit-stream.

In some embodiments, the Gaussian noise filter 340 may comprise various components and/or modules. The Gaussian noise filter 340 may, for example, comprise a singularity detector 342, a singularity filter 344, a threshold filter 346, and/or a refinement module 348. The singularity detector 342 may, according to some embodiments, analyze pixels and/or other metrics associated with an image received from the video input device 330. In some embodiments, the singularity detector 342 may identify pixels associated with anomalies and determine whether such pixels are singularity pixels. Singularity pixels may, for example, be pixels associated with noise and/or Gaussian noise artifacts. According to some embodiments, such as in the case that a pixel is determined to be a singularity pixel, the singularity detector 342 may indicate such a determination to the singularity filter 344. The singularity filter 344 may, for example, process and/or filter the singularity pixel to reduce the noise artifact associated therewith. In some embodiments, the singularity filter 344 may forward the filtered singularity pixels to the video output device 360 (e.g., for further processing and/or display).

According to some embodiments, such as in the case that an analyzed pixel is determined not to be a singularity pixel, the singularity detector 342 may indicate such a determination to the threshold filter 346. The threshold filter 346 may, for example, analyze and/or process the non-singularity pixel to reduce and/or remove noise artifacts. In some embodiments, the threshold filter 346 may utilize different methodology than the singularity filter 344 to reduce noise artifacts. The determination of whether an anomaly pixel is a singularity pixel may, for example, determine the filtering strategy to be utilized to reduce noise and/or Gaussian noise artifacts. In some embodiments, the threshold filter 346 may forward the filtered pixel and/or pixels to the refinement module 348.

The refinement module 348 may, according to some embodiments, utilize information from the edge filter 354 to modify the filtering results from the threshold filter 346. In some embodiments, the pre-edge filter 352 may apply a weighting factor to and/or otherwise process a neighborhood of pixels (e.g., associated with a target pixel to be analyzed) to prepare the neighborhood for an edge detection process. In some embodiments, the pre-edge filter 352 may improve edge detection. According to some embodiments, the pre-edge filter 352 may not be included in the system 300.

In some embodiments, the image and/or video input and/or one or more pixels thereof may be analyzed by the pre-edge filter 352 and/or the edge filter 354 to determine pixels that are associated with edges. The neighborhood of pixels processed by the pre-edge filter 352 may, for example, be provided to the edge filter 354 to determine if one or more pixels are edge pixels. In some embodiments, the pre-edge filter 352 and/or the edge filter 354 may be included in and/or may otherwise be associated with the Gaussian noise filter 340. According to some embodiments, the edge determination information (e.g., provided by the pre-edge filter 352 and/or the edge filter 354) may be utilized by the refinement module 348 to modify the filtering results of the threshold filter 346. The filtering results may, for example, be weighted based upon whether an analyzed pixel (and/or number of pixels) is determined to be edge pixels. In some embodiments, filtering intensity may be reduce in the case that a pixel is an edge pixel to reduce blurring of image edges. The filtering intensity may also or alternatively be increased in the case that a pixel is not an edge pixel to increase the Gaussian noise reduction of the threshold filter 346.

According to some embodiments, the results from the refinement module 348 may be provided to the video output device 360 for further processing and/or display. In some embodiments, the filtering results of the threshold filter 346 and the refinement module 348 may be combined, unioned, and/or otherwise joined with the filtering results of the singularity filter 344. The combined results may, for example, comprise a filtered version of the originally received image, video image, and/or video bit-stream. The combined results may also or alternatively be provided to the video output device 360 for display (e.g., to a user).

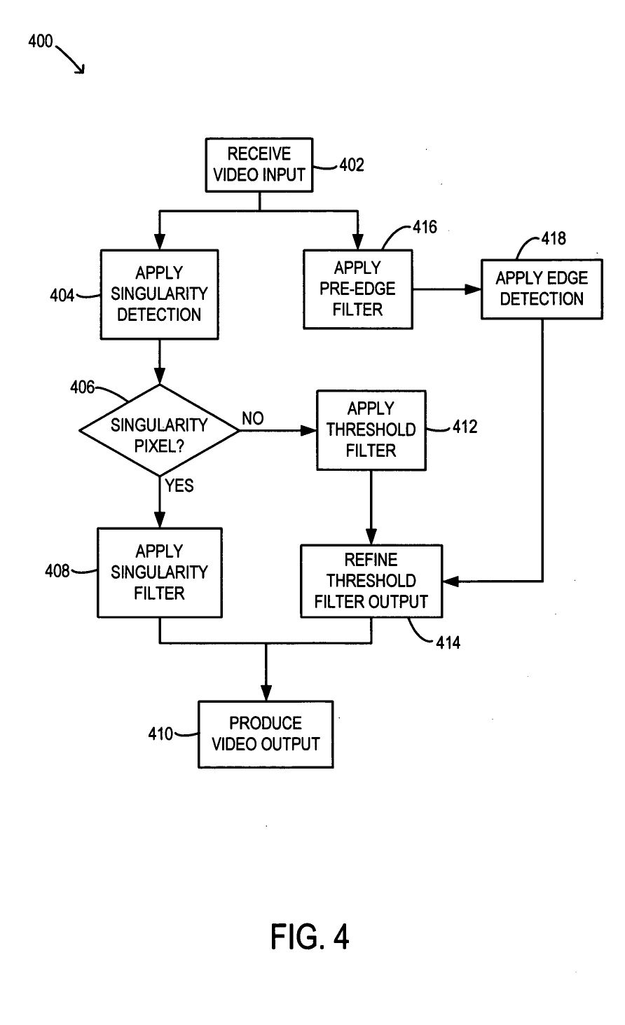

Turning to FIG. 4, a flowchart of a method 400 according to some embodiments is shown. In some embodiments, the method 400 may be conducted by and/or by utilizing the systems 100, 200, 300 and/or may be otherwise associated with the systems 100, 200, 300 and/or any of the system components described in conjunction with any of FIG. 1, FIG. 2, and/or FIG. 3. The method 400 may, for example, be performed by and/or otherwise associated with the post-processing device 130, the video input devices 230, 330, the Gaussian noise filters 240, 340, and/or the Gaussian noise detectors 250 described herein. The flow diagrams described herein do not necessarily imply a fixed order to the actions, and embodiments may be performed in any order that is practicable. Note that any of the methods described herein may be performed by hardware, software (including microcode), firmware, manual means, or any combination thereof. For example, a storage medium may store thereon instructions that when executed by a machine result in performance according to any of the embodiments described herein.

In some embodiments, the method 400 may begin at 402 to receive video input. Video image, still image, video bit-stream, and/or other image input may, for example, be received from a device such as the image decoder 120. In some embodiments, the video input may contain noise artifacts. The video input may, for example, contain Gaussian noise artifacts introduced during transmission, storing, encoding, decoding, and/or other processing of the video input (e.g., introduced prior to being received at 402). According to some embodiments, the video input may be processed and/or filtered to reduce and/or substantially eliminate the Gaussian noise artifacts.

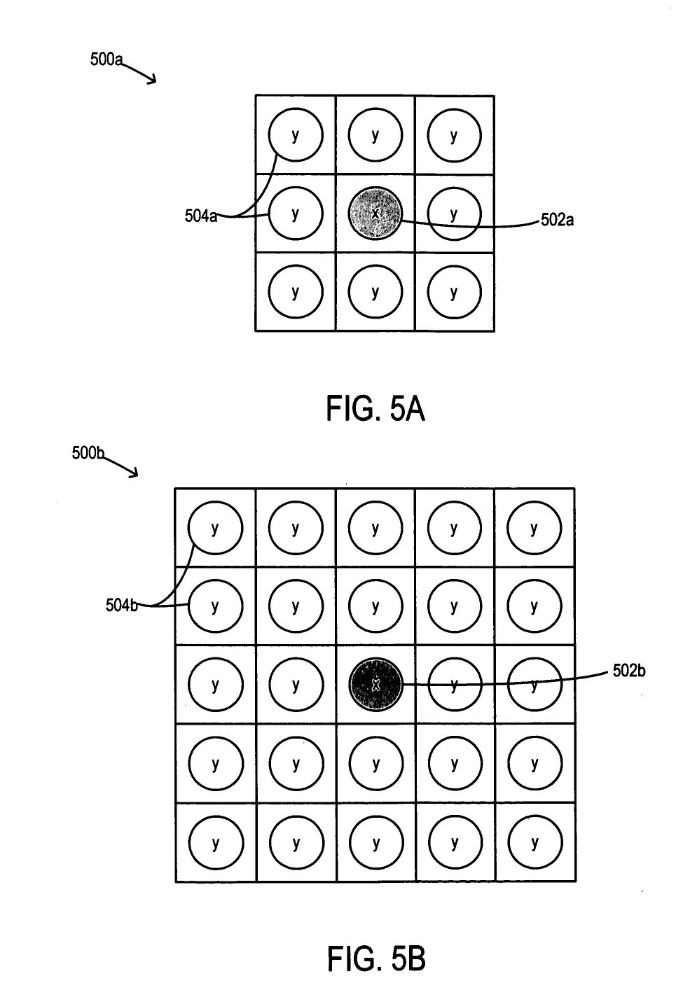

The method 400 may continue, for example, to apply singularity detection at 404. In some embodiments, the singularity detection may be accomplished by a device such as the singularity detector 342 described in conjunction with FIG. 3. According to some embodiments, the singularity detection may comprise analyzing an anomaly pixel that may, for example, be termed a “target pixel” (e.g., the target of the singularity detection). In some embodiments, the singularity detection may further comprise analyzing the target pixel with respect to a neighborhood of surrounding pixels. As shown in FIG. 5A and FIG. 5B, for example, neighborhoods of pixels “NH(x)” 500a-b comprising and/or surrounding a target pixel “x” 502a-b (e.g., the shaded pixel) and neighboring pixels “y” 504a-b may be identified, determined, defined, and/or otherwise associated with the singularity detection at 404.

According to some embodiments, the neighborhood of pixels “NH(x)” 500a-b may comprise different dimensions depending upon the desired configuration for the singularity detection. A first neighborhood of pixels “NH(x)” 500a may, for example, be a three by three matrix of pixels 502a, 504a centered on the target pixel “x” 502a (e.g., comprising a total number of nine pixels 502a, 504a; including the target pixel “x” 502a and eight neighboring pixels “y” 504a), as shown in FIG. 5A. According to some embodiments, the three by three neighborhood 500a may be represented by the term “NH9(x)”, signifying that the first neighborhood 500a includes a total of nine pixels 502, 504.

In some embodiments, a second neighborhood of pixels 500b may be a five by five matrix of pixels 502b, 504b centered on the target pixel “x” 502b (e.g., comprising a total number of twenty-five pixels 502b, 504b; including the target pixel “x” 502b and twenty-four neighboring pixels “y” 504b), as shown in FIG. 5B. According to some embodiments, the five by five neighborhood 500a may be represented by the term “NH25(x)”, signifying that the second neighborhood 500b includes a total of twenty-five pixels 502, 504. In some embodiments, the use of the three by three neighborhood of pixels 500a may be advantageous for identifying one-pixel wide anomalies, while the use of the five by five neighborhood of pixels 500b may be advantageous in identifying two-pixel wide anomalies.

In some embodiments, the singularity detection may comprise analyzing each pixel from a neighborhood of pixels 500a-b as follows:
If (y>x+singular_th) then big_neighbor(y)=1
Else if (y<x-singular_th) then small_neighbor(y)=1
Else regular_neighbor(y)=1, [1]

where “x” is the target pixel 502, “y” is a neighboring pixel 504, and “singular_th” is a pre-defined singularity threshold value. The variables “big_neighbor(y)”, “small_neighbor(y)”, and “regular_neighbor(y)” may, for example, represent pixel types of the neighboring pixels “y” 504 that have values that are larger than, smaller than, and substantially equivalent to the target pixel “x” 502, respectively. In some embodiments, the number of big, small, and/or regular neighboring pixels “y” 504 may be summed to define variables such as “num_big_neighbor”, “num_small_neighbor”, and/or “num_regular_neighbor”, respectively.

The method 400 may then, for example, continue to determine whether the target pixel “x” 502 is a singularity pixel, at 406. The determination may, according to some embodiments, be associated with the number of large and/or small neighboring pixels “y” 504. For example, the singularity of the target pixel “x” 502 may be determined as follows:
If (num_big_neighbor>number_th) OR
(num_small_neighbor>number_th) then singularity_pixel(x)=1
Else regular_pixel(x)=1, [2]

where “number_th” is a pre-determined neighborhood threshold value and the variables “singularity_pixel(x)” and “regular_pixel(x)” represent the singularity status of the target pixel “x” 502. In some embodiments, the “number_th” may be chosen to define a singularity condition depending upon the dimensions of the neighborhood of pixels “NH(x)” 500a-b used. The “number_th” may, for example, be set to a value of seven to detect a one-pixel wide anomaly in a three by three neighborhood of pixels “NH9(x)” 500a and/or set to a value of twenty-two to detect two-pixel wide anomalies in a five by five neighborhood of pixels “NH25(x)” 500b.

According to some embodiments, such as in the case that the target pixel “x” 502 is determined to be a singularity pixel (e.g., singularity_pixel(x)=1), the method 400 may continue to apply a singularity filter at 408. The singularity filtering may, for example, be conducted by a device such as the singularity filter 344 described in conjunction with FIG. 3. According to some embodiments, the singularity filter applied to the singularity pixel “x” 502 may also or alternatively utilize and/or analyze a neighborhood of pixels “NH(x)” 500a-b. The singularity filter may, for example, analyze the three by three neighborhood of pixels “NH9(x)” 500a to filter the singularity pixel “x” 502. The median value of all pixels 502, 504 within the neighborhood “NH9(x)” 500a may, for example, be determined. In some embodiments, the median value of the pixels 502, 504 may then be applied as a new value for the singularity pixel “x” 502, effectively filtering the noise associated therewith. Such singularity filtering may, for example, substantially remove and/or filter anomaly pixels while substantially preserving edge content of the image and/or video input.

According to some embodiments, the results of the singularity filtering at 408 may be utilized to produce video output at 410. The video input may, for example, be filtered of singularity anomaly pixels and provided to a display and/or video output device such as the display and output devices 160, 260, 360 described herein. In some embodiments, such as in the case that the target pixel “x” 502 is determined not to be a singularity pixel, the method 400 may continue to apply a threshold filter at 412. The threshold filtering may, for example, be conducted by a device such as the threshold filter 346 described in conjunction with FIG. 3. In some embodiments, the applying of the threshold filter may comprise removing outlier pixels from a neighborhood of pixels (such as the neighborhoods “NH(x)” 500a-b of FIG. 5A and FIG. 5B). The outliers may, for example, be removed as follows:
If (ABS(x-y)<gaussian_th) then good_neighbor(y)=1
Else bad_neighbor(y)=1, [3]

where “gaussian_th” is a pre-defined Gaussian threshold value, and the variables “good_neighbor(y)” and “bad_neighbor(y)” signify neighboring pixels “y” 504 that are considered acceptable and neighboring pixels “y” 504 that are considered outliers, respectively. In some embodiments, the “gaussian_th” value may be determined by a user and/or programmer (e.g., to setup and/or customize the threshold filtering at 412) and/or may be defined and/or determined from another source. The “gaussian_th” value may, for example, be determined based upon Gaussian noise detection results. In some embodiments, the “gaussian_th” value may be adjusted and/or varied based on the amount of Gaussian noise detected (e.g., by a Gaussian noise detector 250).

According to some embodiments, the neighborhoods “NH(x)” 500a-b may comprise a spatial neighborhood “S(x, k)” and/or a temporal neighborhood “T(x, k−1)”, where “k” represents information associated with the current picture, image, and/or video frame or bit-stream data. The threshold filtering at 412 may, for example, comprise spatial or spatio-temporal threshold filtering. In some embodiments, the spatial neighborhood “S(x, k)” and/or a temporal neighborhood “T(x, k−1)” may be or include five by five neighborhoods “S25(x, k)” and “T25(x, k−1)”, respectively. According to some embodiments, neighboring pixels “y” 504 from the desired neighborhood “NH(x)” 500a-b may be removed in the case that they are determined to be outliers (e.g., bad_neighbor(y)=1). The modified neighborhood “NH(x)” 500a-b may, for example, be referred to as “NH(x)”, “S(x, k)”, “T(x, k−1)”, and/or as other variations as desired.

In some embodiments, such as in the case that the threshold filtering comprises a spatio-temporal filter, a new value (e.g., a filtered value) of the target pixel “x” 502 may be determined using a threshold filter function “G(x)”, as follows:

$$G ( x ) = ( \frac{1}{{\sum }_{y ∈ \underline{NH} ( x , k )}^{} w ( y )} ) \cdot {\sum }_{y ∈ \underline{S} ( x , k )}^{} w 1 ( y ) \cdot y + {\sum }_{y ∈ \underline{T} ( x , k - 1 )}^{} w 2 ( y ) \cdot y , \qquad [ 4 ]$$

where “w1(y)” is a weighting function for spatial reference pixels (e.g., from the current picture and/or image “k”), “w2(y)” is a weighting function for temporal pixels (e.g., from the previous picture and/or image “k−1”), and the first term “1/Σw(y)” is a normalization term for both the spatial and temporal weighting functions. In some embodiments, the spatio-temporal threshold filtering may be simplified and/or altered as required and/or desired (e.g., based on the design and/or capabilities of a system conducting and/or associated with the method 400). According to some embodiments for example, the spatio-temporal filtering described in equation [4] may be quite effective at reducing noise, yet may introduce temporal and/or processing latency undesirable in some systems. In some embodiments, a spatial-only threshold filter may be applied to determine a new value (e.g., a filtered value) of the target pixel “x” 502 via the threshold filter function “G(x)”, as follows:

$$G ( x ) = ( \frac{1}{{\sum }_{y ∈ \underline{S} ( x , k )}^{} w ( y )} ) \cdot {\sum }_{y ∈ \underline{S} ( x , k )}^{} w ( y ) \cdot y , \qquad [ 5 ]$$

where “w(y)” becomes the spatial-only weighting factor. According to some embodiments, the spatial-only threshold filtering represented by equation [5] may provide image quality results similar to those realizable via the spatio-temporal filtering of equation [4], yet may require less processing and/or memory, and eliminates the filtering dependency on temporal image variations (e.g., may be computed in true real-time).

In some embodiments, the method 400 may continue to refine the threshold filter output at 414. The threshold filter output (e.g., as defined by the results of the threshold filter function “G(x)”) may, for example, be modified and/or refined based at least in part on information associated with Gaussian noise detection. At 416, for example, the method 400 may apply a pre-processing and/or pre-edge filter to the video input. In some embodiments, the pre-edge filter may reduce noise levels to improve edge detection capabilities. The pre-filtering is not required but may improve the accuracy of subsequent edge detection.

According to some embodiments, the pre-filtering at 418 may comprise applying a three by three weighting matrix to a three by three neighborhood of pixels “NH9(x)” 500a centered on the target pixel “x” 502 to implement a weighting function “w”. In some embodiments, the weighting matrix employed may be:

$$[ \begin{matrix}1 & 2 & 1 \\ 2 & 4 & 2 \\ 1 & 2 & 1\end{matrix} ] . \qquad [ 6 ]$$

To reduce the complexity of the calculations, this two-dimensional weighting matrix may be decomposed into two one-dimensional matrices:

$$[ \begin{matrix}1 \\ 2 \\ 1\end{matrix} ] * [ \begin{matrix}1 & 2 & 1\end{matrix} ] . \qquad [ 7 ]$$

In some embodiments, the output of the pre-filter for the target pixel “x” 502, which may be a modified three by three neighborhood of pixels “NH9(x)” 500a, may be calculated as follows:

$$\underline{NH 9} ( x ) = ( \frac{1}{{\sum }_{x ∈ NH 9 ( x )}^{} w ( x )} ) \cdot ( {\sum }_{x ∈ NH 9 ( x )}^{} w ( x ) \cdot x + 1 / 2 \cdot {\sum }_{x ∈ NH 9 ( x )}^{} w ( x ) ) , \qquad [ 8 ]$$

where “w(x)” is the value of the weighting matrix [6], [7] at the position of the target pixel “x” 502, and where, given values of the weighting matrices [6] and/or [7], the term “Σw(x)” equals sixteen, giving:

$$\underline{NH 9} ( x ) = ( \frac{1}{16} ) \cdot ( {\sum }_{x ∈ NH 9 ( x )}^{} w ( x ) \cdot x + 8 ) . \qquad [ 9 ]$$

According to some embodiments, the method 400 may continue to apply edge detection at 418. The modified and/or pre-filtered three by three neighborhood of pixels “NH9(x)” 500a may, for example, be utilized to examine the target pixel “x” 502 for edge characteristics. In some embodiments, any method of edge detection that is or becomes known may be employed. According to some embodiments, the so-called “Sobel” edge detection method may be utilized by applying the following matrices:

$$\begin{matrix}E\_h = [ \begin{matrix}- 1 & - 2 & - 1 \\ 0 & 0 & 0 \\ 1 & 2 & 1\end{matrix} ] , & [ 10 ] \\ E\_v = [ \begin{matrix}- 1 & 0 & 1 \\ - 2 & 0 & 2 \\ - 1 & 0 & 1\end{matrix} ] . & [ 11 ]\end{matrix}$$

The first-order Sobel Edge Metric (EM) value may, according to some embodiments, be calculated as follows (as the convolution of the edge detection weighting matrices [10],

with the modified and/or pre-filtered three by three neighborhood of pixels “NH9(x)” 500a from equation [8] or [9]):
EM(x)=|NH9(x)*E_{—}h|+|NH9(x)*E_{—}v|. [12]

In some embodiments, the EM may be utilized to determine if the target pixel “x” 502 is likely to be an edge pixel. According to some embodiments, the edge determination may be realized as follows:
If (EM(x)>edge_th) then edge_pixel(x)=1
Else texture_pixel(x)=1, [13]

where “edge_th” is a pre-defined edge detection value and the variables “edge_pixel” and “texture_pixel” signify target pixels “x” 502 that are considered edge pixels and target pixels “x” 502 that are considered texture pixels (e.g., non-edge pixels), respectively. According to some embodiments, the edge determination at 418 may be utilized in the refinement of the threshold filter output at 414.

For example, a refinement filter function “F(x)” may be applied to the threshold filter results defined by the threshold filter function “G(x)” (e.g., from equation [4] or [5]), as follows:
F(x)=m·x+(1−m)·G(x), [14]

where “m” is a programmable weighting value. In the case that the target pixel “x” 502 is determined to be an edge pixel, for example, the value of “m” may be set to a relatively large magnitude to reduce blurring effects associated with the detected edge. In the case that the target pixel “x” 502 is determined not to be an edge pixel, the value of “m” may be set to a relatively small value to increase noise reduction and/or elimination within the video (and/or image) input.

In some embodiments, the method 400 may then continue to 410 to utilize the refined threshold filter function output “F(x)” to produce video output. According to some embodiments, the threshold filter output “G(x)” and/or the refined threshold filter output “F(x)” may be combined, merged, and/or re-joined with the output from the singularity filter to form, define, and/or complete the video output. The video output may, according to some embodiments, be substantially clearer and/or of higher quality than it was prior to the application of the Gaussian noise filtering provided by the method 400.

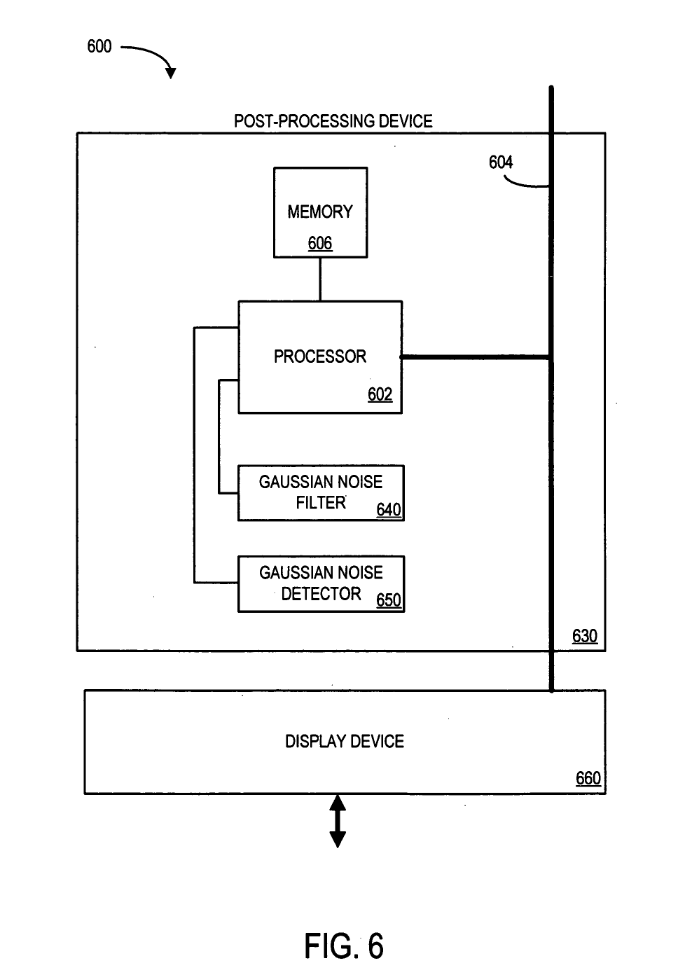

Turning to FIG. 6, a block diagram of a system 600 according to some embodiments is shown. In some embodiments, the system 600 may be similar to the systems 100, 200, 300 and/or may be associated with conducting the method 400 described in conjunction with any of FIG. 1, FIG. 2, FIG. 3, and/or FIG. 4 herein. The system 600 may comprise, for example, a processor 602, a communication path 604, and/or a memory 606, any or all of which may be components of a post-processing device 630. In some embodiments, the post-processing device 630 may also or alternatively comprise a Gaussian noise filter 640 and/or a Gaussian noise detector 650. According to some embodiments, the post-processing device 630 may be in communication (e.g., via the communication path 604) with a display device 660. According to some embodiments, the components 630, 640, 650, 660 of the system 600 may be similar in configuration and/or functionality to the similarly-named components described in conjunction with any of FIG. 1, FIG. 2, and/or FIG. 3. In some embodiments, fewer or more components than are shown in FIG. 6 may be included in the system 600.

The processor 602 may be or include any number of processors, which may be any type or configuration of processor, microprocessor, and/or micro-engine that is or becomes known or available. According to some embodiments, the processor 602 may be an XScale® Processor such as an Intel® PXA270 XScale® processor. The communication path 604 may be any type or configuration of communication path that is or becomes known. The communication path 604 may, for example, comprise a port, cable, transmitter, receiver, and/or network interface device for managing and/or facilitating communications (e.g., between the post-processing device 630 and the display device 660). The memory 606 may be or include, according to some embodiments, one or more magnetic storage devices, such as hard disks, one or more optical storage devices, and/or solid state storage. The memory 606 may store, for example, applications, programs, procedures, and/or modules that store instructions to be executed by the processor 602. The memory 606 may comprise, according to some embodiments, any type of memory for storing data, such as a Single Data Rate Random Access Memory (SDR-RAM), a Double Data Rate Random Access Memory (DDR-RAM), or a Programmable Read Only Memory (PROM).

According to some embodiments, the memory 606 may store instructions operable to be executed by the processor 602 to perform Gaussian noise filtering in accordance with embodiments described herein. In some embodiments, the Gaussian noise filter 640 may filter Gaussian noise in accordance with embodiments described herein. The Gaussian noise filter 640 may, for example, utilize a combination of singularity and threshold detection and/or filtering to analyze an image. The Gaussian noise filter 640 may also or alternatively utilize information received from the Gaussian noise detector 650 to determine how and/or when to filter images and/or video. In some embodiments, either or both of the Gaussian noise filter 640 and the Gaussian noise detector 650 may be incorporated in the same device. According to some embodiments, either or both of the Gaussian noise filter 640 and the Gaussian noise detector 650 may be functionally defined and/or executed via instructions stored in the memory 606 (e.g., they may be or include programs, modules, and/or other instructions or code).

The several embodiments described herein are solely for the purpose of illustration. Other embodiments may be practiced with modifications and alterations limited only by the claims.

What is claimed is:

1. A method conducted by a Gaussian noise filter, comprising:
receiving, at the Gaussian noise filter, video input comprising data associated with a plurality of video pixels;
identifying a pixel from the plurality of pixels that is associated with an anomaly;
determining if the identified pixel is a singularity pixel;
filtering the video input, in the case that the pixel is a singularity pixel, utilizing a singularity filter;
filtering the video input, in the case that the pixel is not a singularity pixel, utilizing a threshold filter;
refining the filtered video input utilizing data associated with edge detection to create video output; and
providing the video output to a video output device.

2. The method of claim 1, further comprising:
applying a pre-edge detection filter to the video input to reduce noise within the video input; and
determining if the identified pixel is an edge pixel.

3. The method of claim 2, where the refining is based at least in part on the determination of whether the identified pixel is an edge pixel.

4. The method of claim 2, wherein the applying of the pre-edge detection filter and the determination of whether the identified pixel is an edge pixel are conducted by a Gaussian noise detector.

5. The method of claim 1, wherein the refining is conducted upon the filtered video input from the threshold filter.

6. The method of claim 1, wherein the determination of whether the identified pixel is a singularity pixel comprises:
determining a neighborhood of pixels from the plurality of pixels that are proximate to the identified pixel;
comparing a value of each of the neighborhood pixels to a value of the identified pixel plus a singularity threshold value to determine a type of the neighborhood pixel, at least by:
determining, in the case that the value of the neighborhood pixel is greater than the value of the identified pixel plus the singularity threshold value, that the neighborhood pixel is a big neighborhood pixel;
determining, in the case that the value of the neighborhood pixel is less than the value of the identified pixel plus the singularity threshold value, that the neighborhood pixel is a small neighborhood pixel; and
determining, in the case that the value of the neighborhood pixel is equivalent to the value of the identified pixel plus the singularity threshold value, that the neighborhood pixel is a regular neighborhood pixel;
summing the number of big and small neighborhood pixels; and
determining, in the case that the number of big neighborhood pixels or the number of small neighborhood pixels is larger than a neighborhood threshold value, that the identified pixel is a singularity pixel.

7. The method of claim 1, wherein the filtering of the video input utilizing the singularity filter comprises:
determining a neighborhood of pixels from the plurality of pixels that are proximate to the singularity pixel;
identifying a value of each of the neighborhood pixels and a value of the singularity pixel;
determining the median of all the identified values; and
assigning the median value to the singularity pixel.

8. The method of claim 1, wherein the threshold filter comprises at least one of a spatio-temporal threshold filter or a spatial threshold filter.

9. The method of claim 8, wherein the filtering of the video input utilizing the threshold filter comprises:
determining a neighborhood of pixels from the plurality of pixels that are proximate to the identified pixel;
removing outlier pixels from the neighborhood of pixels, at least by:
determining the absolute value of a value of the identified pixel minus a value of a neighborhood pixel; and
removing, in the case that the absolute value is greater than or equal to a Gaussian threshold value, the neighborhood pixel from the neighborhood of pixels to create a modified neighborhood of pixels;
determining a new value for the identified pixel at least by:
applying a threshold formula to the identified pixel and the modified neighborhood of pixels.

10. The method of claim 9, wherein the Gaussian threshold value is determined based at least in part on information associated with a Gaussian noise detector.

11. The method of claim 9, wherein the threshold filter comprises the spatio-temporal threshold filter and the modified neighborhood of pixels comprises a modified spatial neighborhood of pixels and a modified temporal neighborhood of pixels, the applying of the threshold formula comprising:
multiplying each pixel of the spatial neighborhood of pixels by a spatial weighting function;
summing the weighted spatial pixels to produce a first term;
multiplying each pixel of the temporal neighborhood of pixels by a temporal weighting function;
summing the weighted temporal pixels to produce a second term;
adding the first and second terms to produce a result; and
normalizing the result to produce a new value for the identified pixel.

12. The method of claim 9, wherein the threshold filter comprises the spatial threshold filter, the applying of the threshold formula comprising:
multiplying each pixel of the neighborhood of pixels by a spatial weighting function;
summing the weighted spatial pixels to produce a result; and
normalizing the result to produce a new value for the identified pixel.

13. The method of claim 1, wherein the refining of the filtered video input comprises:
subtracting a refinement value from the number one to produce a first term;
multiplying the first term by a result value associated with the identified pixel of the filtered video input to produce a second term;
multiplying a value of the identified pixel by the refinement value to produce a third term; and
adding the second and third terms to produce a new refined value of the identified pixel.

14. The method of claim 13, wherein the refinement value comprises a large value in the case that the identified pixel is determined to be an edge pixel and otherwise comprises a small value.

15. An Gaussian noise filter, comprising:
a storage medium having stored thereon instructions that when executed by a machine result in the following:
receiving, at the Gaussian noise filter, video input comprising data associated with a plurality of video pixels;
identifying a pixel from the plurality of pixels that is associated with an anomaly;
determining if the identified pixel is a singularity pixel;
filtering the video input, in the case that the pixel is a singularity pixel, utilizing a singularity filter;
filtering the video input, in the case that the pixel is not a singularity pixel, utilizing a threshold filter;
refining the filtered video input utilizing data associated with edge detection to create video output; and
providing the video output to a video output device.

16. The Gaussian noise filter of claim 15, wherein the determination of whether the identified pixel is a singularity pixel comprises:
determining a neighborhood of pixels from the plurality of pixels that are proximate to the identified pixel;
comparing a value of each of the neighborhood pixels to a value of the identified pixel plus a singularity threshold value to determine a type of the neighborhood pixel, at least by:
determining, in the case that the value of the neighborhood pixel is greater than the value of the identified pixel plus the singularity threshold value, that the neighborhood pixel is a big neighborhood pixel;
determining, in the case that the value of the neighborhood pixel is less than the value of the identified pixel plus the singularity threshold value, that the neighborhood pixel is a small neighborhood pixel; and
determining, in the case that the value of the neighborhood pixel is equivalent to the value of the identified pixel plus the singularity threshold value, that the neighborhood pixel is a regular neighborhood pixel;
summing the number of big and small neighborhood pixels; and
determining, in the case that the number of big neighborhood pixels or the number of small neighborhood pixels is larger than a neighborhood threshold value, that the identified pixel is a singularity pixel.

17. The Gaussian noise filter of claim 15, wherein the filtering of the video input utilizing the singularity filter comprises:
determining a neighborhood of pixels from the plurality of pixels that are proximate to the singularity pixel;
identifying a value of each of the neighborhood pixels and a value of the singularity pixel;
determining the median of all the identified values; and
assigning the median value to the singularity pixel.

18. The Gaussian noise filter of claim 15, wherein the filtering of the video input utilizing the threshold filter comprises:
determining a neighborhood of pixels from the plurality of pixels that are proximate to the identified pixel;
removing outlier pixels from the neighborhood of pixels, at least by:
determining the absolute value of a value of the identified pixel minus a value of a neighborhood pixel; and
removing, in the case that the absolute value is greater than or equal to a Gaussian threshold value, the neighborhood pixel from the neighborhood of pixels to create a modified neighborhood of pixels;
determining a new value for the identified pixel at least by:
applying a threshold formula to the identified pixel and the modified neighborhood of pixels.

19. The Gaussian noise filter of claim 15, wherein the refining of the filtered video input comprises:
subtracting a refinement value from the number one to produce a first term;
multiplying the first term by a result value associated with the identified pixel of the filtered video input to produce a second term;
multiplying a value of the identified pixel by the refinement value to produce a third term; and
adding the second and third terms to produce a new refined value of the identified pixel.

20. A system, comprising:
an input path to receive video input comprising data associated with a plurality of video pixels;
a processor;
a double data rate memory coupled to the processor, wherein the double data rate memory is to store instructions that when executed by the processor result in the following:
identifying a pixel from the plurality of pixels that is associated with an anomaly;
determining if the identified pixel is a singularity pixel;
filtering the video input, in the case that the pixel is a singularity pixel, utilizing a singularity filter;
filtering the video input, in the case that the pixel is not a singularity pixel, utilizing a threshold filter; and
refining the filtered video input utilizing data associated with edge detection to create video output; and
an output path to provide the video output to a video output device.

21. The system of claim 20, wherein the system comprises a Gaussian noise filter.

22. The system of claim 20, further comprising:
a Gaussian noise detector to provide the data associated with edge detection.
